(19) United States
(12) Patent Application Publication
(10) Pub. No.: US 2002/0135161 A1
(43) Pub. Date: Sep. 26, 2002

(54) Glass fiber reinforced thermoplastic components

(76) Inventors: Tony M. Lamb, Holland, MI (US); Heather R. Springer, West Olive, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/817,438

(22) Filed: Mar. 26, 2001

(51) Int. Cl. B60R 21/16

(52) U.S. Cl. 280/728.3

(57) ABSTRACT

Plastic structural components suitable for use in automotive applications and exhibiting improved impact strength, energy absorption, and reduced fragmentation upon impact are made from a fiber reinforced thermoplastic resin. The improved properties are achieved by using reinforcing fibers having a weight average length of at least about 4 mm. Specific applications include vehicle instrument panel substrates that are used for supporting a foam padding and an aesthetic covering, and concealing an inflatable air bag that deploys into the occupant compartment of the vehicle in the event of a severe collision.

### FIELD OF THE INVENTION

This invention relates to fiber reinforced plastic components, and more particularly to glass fiber reinforced thermoplastic components exhibiting improved impact resistance and energy absorption

### BACKGROUND OF THE INVENTION

Glass fiber reinforced thermoplastic materials are used for a variety of applications wherein plastic structural components exhibiting excellent mechanical properties such as impact resistance are required. Examples of such applications include structural components used in the fabrication of vehicle instrument panel assemblies concealing an inflatable air bag that deploys into the occupant compartment to protect an occupant against injury in the event of severe collision. More specifically, glass fiber reinforced thermoplastics such as polycarbonate, polycarbonate/acrylonitrile-butadiene-styrene terpolymer blends, and styrenemaleic anhydride copolymers have been used as structural support members disposed between an inflatable air bag and an instrument panel, wherein the glass fiber reinforced thermoplastic structural member supports an instrument panel or instrument panel cover, which is typically comprised of a flexible foam such as an elastomeric polyurethane foam having a covering or skin, such as a polyvinyl chloride sheet, that faces the vehicle occupant compartment. The glass fiber reinforced thermoplastic structural member (i.e., instrument panel retainer), in addition to exhibiting good structural properties, must also be capable of withstanding high impact in the event that the inflatable air bag is deployed. More specifically, the retainer must exhibit high impact resistance and energy absorption properties that reduce fragmentation upon impact with the inflatable air bag during deployment.

U.S. Pat. No. 5,939,001 discloses a process for manufacturing fiber-reinforced thermoplastics that demonstrate high impact resistance. The process involves blending a thermoplastic resin with reinforcing fibers, plasticating the blend with the addition of heat inside a screw-type extruder and extruding a plasticated mass for molding. The thermoplastic resin is fed to the screw-type extruder in powder form and in a blend with the reinforcing fibers. Improved mechanical properties, and in particular improved high impact resistance, are achieved by metering a thermoplastic resin in powder form to the screw extruder, wherein the mean particle size of the power is less than 1 mm and the ratio of the length of the fibers to the mean particle size of the resin is greater than about 12:1. Although the patent discloses an example in which 12 mm long glass fibers are used, the glass fibers are broken during the extrusion process whereby the average length of the fibers in the extrudate is less than 4 mm. A component compression molded from the extrudate meets existing standards for impact resistance and energy absorption and exhibits low or no fragmentation upon impact with an air bag. However, improved impact resistance and component reliability would be desired.

Similar problems exist with other conventional fiber reinforced thermoplastic materials. For example, components made by conventional injection molding techniques using glass fiber reinforced polycarbonate, polycarbonate/acrylonitrile-butadiene-styrene, or styrene-maleic anhydride copolymers typically have very short glass reinforcing fibers, such as from about 2 mm or less. As a result, these components do not exhibit the desired impact resistance and energy absorption properties that are needed to prevent fragmentation for certain applications. Further, it has been determined that components made from glass fiber reinforced thermoplastic materials exhibit a further reduction in mechanical properties in direct relationship to the length of the fibers due to deterioration of the polymer after being subjected to accelerated aging conditions. The length of the fiber affects the initial i.e., starting point at which deterioration begins. Known instrument panel substrates disposed in the deployment path of an inflatable air bag tend to fragment upon impact with an inflatable air bag during deployment of the air bag, propelling small pieces of plastic into the occupant compartment. Based on accelerated aging tests, it is expected that problems associated with fragmentation of a conventional instrument panel substrate will increase with the age of the instrument panel substrate.

### SUMMARY OF THE INVENTION

In accordance with the invention, fiber reinforced thermoplastic components exhibiting improved impact resistance and energy absorption properties are provided. In particular, components that do not form fragments upon impact with a vehicle air bag during deployment of the air bag are provided.

In accordance with a first aspect of the invention, a plastic component is comprised of an extruded fiber reinforced thermoplastic resin molded into a desired component shape, wherein the average length of the reinforcing fibers in the plastic component is at least about 5 mm. In a preferred embodiment the component is a vehicle instrument panel substrate.

In accordance with another aspect of the invention, a vehicle instrument panel substrate having a concealed air bag door is compression molded from an extruded fiber reinforced thermoplastic resin having an insert molded air bag door. The instrument panel substrate is cut through to define a door opening. The sheet metal door panel includes a first section embedded in the instrument panel substrate away from the door opening, a second section embedded in the instrument panel substrate in the door opening, and at least one hinge connecting the first section of the metal door panel to the second section of the metal door panel.

In accordance with another aspect of the invention, a vehicle instrument panel substrate having a concealed air bag door is provided. The instrument panel substrate is made of fiber reinforced thermoplastic resin molded into the desired shape of the vehicle instrument panel substrate. The concealed air bag door is defined by pre-scored and/or precut lines that allow the door to swing from a closed position to an open position when an air bag positioned behind the concealed door is deployed. In order to provide improved impact resistance and energy absorption to reduce fragmentation during deployment of the air bag, the average length of the reinforcing fibers is at least about 4 mm.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of a vehicle instrument panel having parts broken away.

FIG. 2 is a section view taken in the direction of arrows 2-2 of FIG. 1, showing the instrument panel structure.

FIG. 3 is an enlarged, fragmented, plan view of the vehicle instrument panel of FIGS. 1 and 2.

### DETAILED DESCRIPTION OF PREFERRED EMBODIMENTS

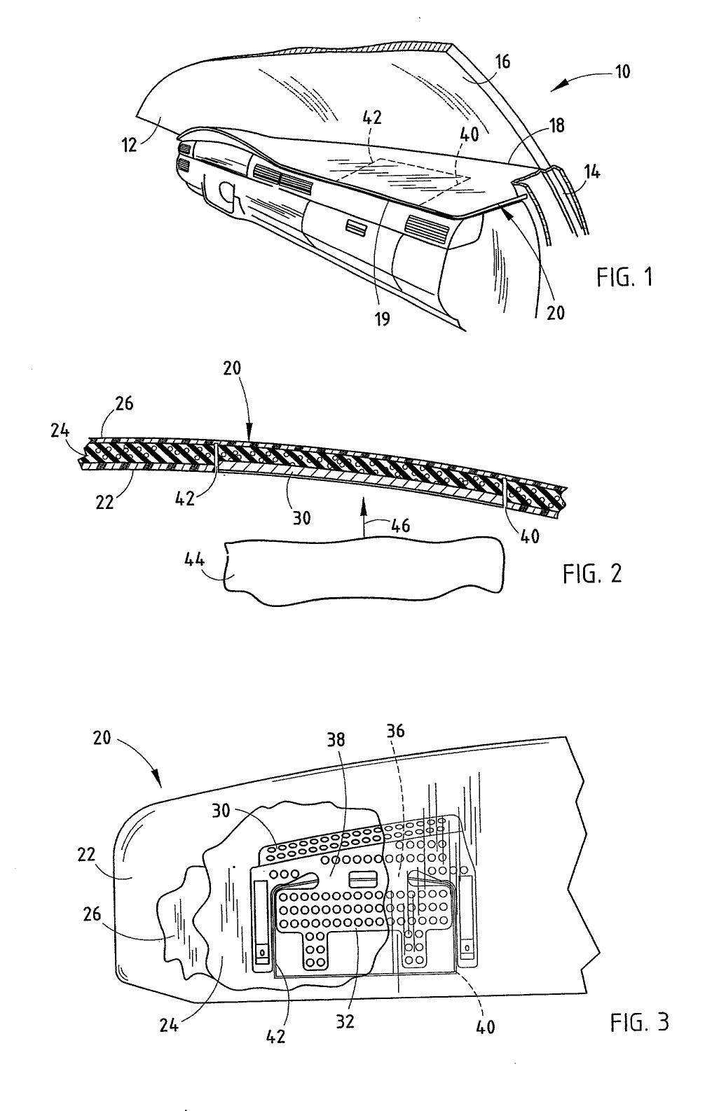

In FIG. 1, there is shown an instrument panel 10 extending transversely across a vehicle between pillars 12 and 14 supporting a windshield 16. Instrument panel 10 includes an instrument panel cover 20 which is generally horizontal and extends transversely across the vehicle between pillars 12 and 14 and also extends longitudinally between a forward most edge 18 thereof adjacent the windshield 16 and a rearward most edge 19 closest to the occupant compartment. FIG. 2 shows instrument panel cover 20 cut away to reveal a molded plastic lower retainer panel or substrate 22, a layer of foam padding 24, and a decorative cover layer 26 such as a polyvinyl chloride layer.

Embedded within vehicle instrument panel substrate or retainer 22 is an insert molded air bag door 28 which helps define a concealed air bag door and hinges that allow the concealed door to swing from a closed position to an open position when an air bag positioned behind the conceal door is deployed. Air bag door 28, indicated by dashed lines in FIG. 3, includes a first section 30 embedded in the instrument panel substrate 22 away from the door opening, and a second section 32 embedded in the instrument panel substrate 22 in the door opening. The air bag door opening is generally defined by pre-scored, thinned, pre-cut or similar lines 40, 42 (also indicated in FIG. 2 by dashed lines) that provide weakened areas that allow the concealed door to swing from a closed position to an open position upon deployment of an air bag beneath the concealed door. Sections 30 and 32 of air bag door 28 are connected by internal hinge sections 36 and 38 which allow the concealed door to open forwardly toward the windshield, away from the occupancy area of the vehicle, when the air bag is deployed.

As shown in FIG. 2, the concealed door of instrument panel structure 10 is located between the dashed lines of the instrument panel cover indicated at reference numerals 40 and 42 above an inflatable air bag indicated schematically by reference numeral 44, which deploys, in the event of an accident, in the direction indicated by arrow 46. Retainer or substrate 22 is disposed between the air bag 44 and the vehicle occupancy compartment. Foam padding 24 and decorative covering 26 may also be pre-cut, pre-scored or otherwise be provided with weakened lines to facilitate opening of the concealed door during deployment of air bag 44. The weakened lines can be made with a hot knife, or more preferably with a laser cutting tool that cuts through retainer or substrate 22, through foam padding 24, and into, but not through decorative cover layer 26.

Instrument panel substrate or retainer 22 is formed from a thermoplastic resin containing reinforcing fibers. Suitable resins include those that have been generally used in the industry, including polycarbonate resins, styrene-maleic acid copolymer resins, acrylonitrile-butadiene-styrene copolymer resins, blends of polycarbonate and ABS, etc., with polypropylene being a preferred thermoplastic resins for use in the invention.

In order to provide the needed impact strength and energy absorption properties to prevent fragmentation of the plastic retainer during impact with an air bag during deployment, it is important that the reinforcing fibers are at least about 4 mm in length, more preferably at least 5 mm. Various reinforcing fibers may be used, including cut glass, natural and synthetic fibers, with examples including carbon fibers, graphite fibers, polyolefin fibers, polyester fibers (e.g., polyethylene tetraphthalate fibers), etc. However, on account of their low cost and excellent reinforcing properties, glass-reinforcing fibers are preferred. The fiber reinforced thermoplastic components of this invention (e.g., a vehicle instrument panel substrate) typically comprise from about 10 to about 50 percent glass fibers by weight, more preferably from about 20 to about 40 percent, and even more preferably from about 25 to about 35 percent by weight. The expression “average length” as used to describe the reinforcing fibers of this invention refers to a weight average length, which is defined as the sum of the products of the weigh fraction of glass fibers of any particular length, for all lengths of glass fibers in the component. The weight average length of the glass fibers in a molded fiber reinforced component can be determined by dissolving, pyrolyzing, or otherwise destroying the thermoplastic resin or separating the thermoplastic resin from the glass fibers. The glass fibers are then classified by size and the weight average length of the glass fibers can be approximated by summing the products of the weight fraction of glass fibers in a particular length classification with the average length in the classification.

In accordance with this invention, the weight average length of the reinforcing glass fibers is at least about 4 mm, with preferred weight average length of the reinforcing glass fiber being at least about 5 mm up to about 8 mm. It has been determined that the impact strength of components made in accordance with this invention (e.g., polypropylene resin having a glass reinforcing fiber content of about 30 percent, with a weight average glass fiber length of about 4 mm to about 6 mm) is from about 40 to about 55 mJ/mm² after being heat aged at a temperature of from 85° C. to 115° C. for over 1,000 hours. In contrast, conventional glass fiber reinforced styrene-maleic acid having a 30 percent fiber content, with relatively short fibers having a weight average length of less than 1 mm initially have an impact strength of about 20 mJ/mm², which deteriorates to about 5 mJ/mm² after 1,000 hours of accelerated aging at 115° C.

A direct comparison was made between a glass fiber reinforced polypropylene having a 40 percent by weight glass fiber content with a weight average length of about 3.1 mm, and a glass fiber reinforced polypropylene having a glass fiber content of 40 percent by weight, with a weight average length of about 7.5 mm. The material with the 3.1 mm long fibers had an impact strength at 21° C. of 9.1 kJ/m². The material with the 7.5 mm long fibers (weight average) had an impact strength of 30.0 kJ/m² at 21° C., and an impact strength of 31.5 kJ/m² at 40° C.

Unless care is taken during the preparation of a glass fiber reinforced thermoplastic component, the glass fibers tend to break up into smaller pieces, which do not provide the desired fiber length or improved impact resistance and energy absorption properties, and therefore, do not achieve the desired reduction or elimination of fragmentation upon impact with a deploying air bag. Fiber reinforced thermoplastic components are typically produced by introducing reinforcing fibers and thermoplastic resin into a screw-type extruder. The thermoplastic resin and fibers are plasticated and a plastic mass is extruded directly into a mold tool, wherein the finished component is made by compression molding in the tool.

It has been discovered that it is possible to start with standard 12 mm long glass fibers and achieve a final weight average length of at least 4 or 5 mm by utilizing a two stage process in which the thermoplastic material is plasticated in a first extruder, and the plasticated thermoplastic resin is fed into a second extruder along with the reinforcing fibers of standard length (e.g., 12 mm). As an alternative, a weight average fiber length in excess of 4 mm can also be achieved with a plasticater specifically designed for the production of molded parts made of long glass fiber reinforced thermoplastics (e.g., polypropylene with glass fiber reinforcement). Plasticaters designed for the processing of long glass fiber reinforced thermoplastics are now commercially available. The melting of the material is carried out in an electrically heated, low wear, plasticating cylinder, with an internally heated special screw for long glass fiber reinforced thermoplastics. In order to reduce or prevent reduction of fiber length, the screw is operated at a relatively low speed such as from about 10 to about 45 rpm. Suitable screws and other equipment for maintaining long glass fiber length are commercially available.

As an alternative, the thermoplastic resin and fibers may be plasticized and injected directly into a mold tool. It is possible to obtain long glass fibers (about 4 mm or greater) in an injection molded part by appropriate modification of conventional injection molding equipment. A modification that promotes longer glass fibers in an injection molded part involves use of recently developed mixing screws having screw fight conducive to maintaining long glass fiber length. Such mixing screws are commercially available from vendors such as C. A. Lawton Co. and others. Recommended screws fights are also available from DSM Inc. Another modification that can be made to promote long glass fibers in an injection molded part is to make the flow gate and/or injection sprue opening as large as possible to minimize shear forces that may break the glass fibers upon injection. Ideally, the point of injection could be at the parting line where the mold tool comes together, or at least in the tool where the final part thickness is at a maximum to minimize stresses from material flow in the tool. Simple mold flow analyses can be used to determine the appropriate point of injection. Another modification that can be used to promote long glass fibers in an injection molded part is to eliminate the check valve or ball check ring typically used in injection molding equipment to prevent material back flow and maintain packing pressure in the tool. Many newer injection molding machines can maintain material pressure via improvements in controllers and software.

Although the invention has been described with respect to a particular instrument panel substrate or retainer extending between the front pillars of a vehicle and having a concealed door through which an inflatable air bag may be deployed, those having ordinary skill in the art will appreciate that the principles of this invention may be applied to the manufacture of retainers or substrates having other configurations, which do not necessarily extend between the front pillars of a vehicle, and which do not necessarily have the concealed door described with respect to the illustrated embodiment. Further, the principles of this invention may be applied to the fabrication of various components requiring good impact strength, energy absorption, and/or resistance to fragmentation upon impact.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A vehicle instrument panel substrate or retainer comprising a fiber reinforced thermoplastic resin molded into a desired shape of the instrument panel, wherein the weight average length of the reinforcing fibers is at least about 4 mm.

2. The substrate of claim 1, wherein the reinforcing fibers are glass fibers.

3. The substrate of claim 1, wherein the thermoplastic resin is selected from the group consisting of polycarbonate, styrene-maleic acid, acrylonitrile-butadiene-styrene, and a blend of polycarbonate and acrylonitrile-butadiene-styrene.

4. The substrate of claim 1, wherein the weight average length of the reinforcing fibers is at least about 5 mm.

5. The substrate of claim 1, wherein the thermoplastic resin is polypropylene.

6. The substrate of claim 1, wherein the reinforcing fibers are glass fibers and the thermoplastic resin is selected from the group consisting of polycarbonate, styrene-maleic acid, acrylonitrile-butadiene-styrene, and a blend of polycarbonate and acrylonitrile-butadiene-styrene.

7. The substrate of claim 1, wherein the reinforcing fibers are glass fibers and the thermoplastic resin is polypropylene.

8. A vehicle instrument panel substrate having a concealed air bag door, comprising:
a fiber reinforced thermoplastic resin that has been molded into the desired shape of the vehicle instrument panel substrate, the vehicle instrument substrate including an insert molded sheet metal door panel, the instrument panel substrate having weakened lines that define and facilitate opening of the concealed door, the sheet metal door panel including a first section embedded in the instrument panel substrate away from the door opening, a second section embedded in the instrument panel substrate in the door opening, and at least one hinge connecting the first section of the metal door panel to the second section of the metal door panel, the reinforcing fibers are glass fibers having a weight average length of at least about 4 mm.

9. The substrate of claim 8, wherein the thermoplastic resin is selected from the group consisting of polycarbonate, styrene-maleic acid, acrylonitrile-butadiene-styrene, and a blend of polycarbonate and acrylonitrile-butadiene-styrene.

10. The substrate of claim 8, wherein the thermoplastic resin is polypropylene.

11. The substrate of claim 8, wherein the reinforcing fibers are glass fibers and the thermoplastic resin is selected from the group consisting of polycarbonate, styrene-maleic acid, acrylonitrile-butadiene-styrene, and a blend of polycarbonate and acrylonitrile-butadiene-styrene.

12. The substrate of claim 8, wherein the reinforcing fibers are glass fibers and the thermoplastic resin is polypropylene.

13. A vehicle instrument panel substrate having a concealed air bag door comprising:
a fiber reinforced thermoplastic resin molded into the desired shape of the vehicle instrument panel substrate, the concealed air bag door being defined by weakened lines that allow the door to swing from a closed position to an open position when an air bag position behind the concealed door is deployed, wherein the average length of the reinforcing fibers is at least about 4 mm.

14. The substrate of claim 13, wherein the reinforcing fibers are glass fibers.

15. The substrate of claim 13, wherein the thermoplastic resin is selected from the group consisting of polycarbonate, styrene-maleic acid, acrylonitrile-butadiene-styrene, and a blend of polycarbonate and acrylonitrile-butadiene-styrene.

16. The substrate of claim 13, wherein the thermoplastic resin is polypropylene.

17. The substrate of claim 13, wherein the reinforcing fibers are glass fibers and the thermoplastic resin is selected from the group consisting of polycarbonate, styrene-maleic acid, acrylonitrile-butadiene-styrene, and a blend of polycarbonate and acrylonitrile-butadiene-styrene.

18. The substrate of claim 13, wherein the reinforcing fibers are glass fibers and the thermoplastic resin is polypropylene.

19. A component comprising a glass fiber reinforced thermoplastic resin molded into a desired shape, wherein the average length of the reinforcing fibers is at least about 5 mm.

20. The component of claim 19, wherein the thermoplastic resin is selected from the group consisting of polycarbonate, styrene-maleic acid, acrylonitrile-butadiene-styrene, and a blend of polycarbonate and acrylonitrile-butadiene-styrene.

21. The component of claim 19, wherein the thermoplastic resin is polypropylene.

22. A process of making a fiber reinforced component exhibiting excellent impact strength, energy absorption, and low fragmentation upon impact, comprising:
extruding a thermoplastic resin containing reinforcing fibers having a weight average length of at least about 4 mm;
depositing the extrudate into a mold; and
compression molding the deposit into a desired shape of the component.

23. The process of claim 22, wherein the reinforcing fibers are glass fibers.

24. The process of claim 22, wherein the thermoplastic resin is selected from the group consisting of polycarbonate, styrene-maleic acid, acrylonitrile-butadiene-styrene, and a blend of polycarbonate and acrylonitrile-butadiene-styrene.

25. The process of claim 22, wherein the thermoplastic resin is polypropylene.

26. The process of claim 22, wherein the reinforcing fibers are glass fibers and the thermoplastic resin is selected from the group consisting of polycarbonate, styrene-maleic acid, acrylonitrile-butadiene-styrene, and a blend of polycarbonate and acrylonitrile-butadiene-styrene.

27. The process of claim 22, wherein the reinforcing fibers are glass fibers and the thermoplastic resin is polypropylene.
